(19) United States
(12) Patent Application Publication
(10) Pub. No.: US 2016/0315980 A1
(43) Pub. Date: Oct. 27, 2016

(54) METHOD AND APPARATUS FOR ESTABLISHING A NETWORK CONNECTION WITH ONE OR MORE STREAM FEATURES

(71) Applicant: NOKIA TECHNOLOGIES OY, Espoo (FI)

(72) Inventor: Yongbeom Pak, Oulu (FI)

(21) Appl. No.: 15/103,442

(22) PCT Filed: Dec. 13, 2013
(86) PCT No.: PCT/IB2013/060939

§ 371 Date: Jun. 10, 2016

(51) Int. Cl. H04L 29/06

(52) U.S. Cl. CPC H04L 65/4069; H04L 69/24

(57) ABSTRACT

A method, apparatus and computer program product are provided to facilitate the efficient establishment of a network connection that supports a stream having a plurality of stream features. In the context of a method, communication is caused to be provided with a network entity in order to establish a network connection that supports a stream with the network entity. The stream is associated with a plurality of stream features. The method may also include identifying one or more stream features from among the plurality of stream features based upon a feature negotiation conducted in conjunction with a prior network connection. The method may further include causing the network entity to be informed of the one or more stream features and causing the stream to be utilized with the one or more stream features.

### TECHNOLOGICAL FIELD

An example embodiment of the present invention relates generally to the establishment of a network connection and, more particularly, to a method, apparatus and computer program product for establishing a network connection that supports a stream having one or more stream features.

### BACKGROUND

Network connections may be established between a client device and a server for a variety of purposes including, for example, for the provision of internet services. Network connections may be supported by a variety of different protocols including eXtensible Messaging and Presence Protocol (XMPP) which permits a stream, such as an extensible markup language (XML) stream, to be established between the client device and the server. XMPP provides flexibility in terms of the stream features that are available. However, the number of features supported by XMPP comes at the cost of additional feature negotiation messages that must be exchanged between the client device and the server in order to define the particular set of features to be employed during the respective network connection.

The additional feature negotiation messages contribute to a relatively lengthy authentication sequence that may be required to establish an XMPP connection. A lengthy authentication sequence may, in turn, cause increased data consumption, increased battery usage and longer latency to be experienced by the client device. From the network perspective, a longer authentication sequence may require a server to expend additional processing resources to establish a network connection. The lengthy authentication sequence must be repeated during the establishment of each network connection such that connectivity issues that cause a network connection to be required to be repeatedly reestablished may further increase the delay and data consumption experienced by the client devices.

By way of example, FIG. 1 depicts the initial exchange of messages between a client device 10, a client router 12 and a server 14 in conjunction with the establishment of a network connection supported by XMPP. In this regard, the initial messages exchanged by the client device and the client router and shown in FIG. 1 provide for the XMPP connection and authentication. As shown, a number of the messages relate to feature negotiations in which the client device is advised of the plurality of stream features that are available and the client device, in turn, separately identifies the features that are to be utilized in conjunction with the network connection. See, for example, the messages identified as Messages 2-10. The XMPP connection and authentication process may include additional messages relating to other features, such as bind, vcard, roster, presences and the like, which will depend upon the client device. This exchange of messages may take longer and consume more processing resources than is desired. Further, the issues associated with the XMPP connection and authentication process may be exacerbated by having to repeat the XMPP connection and authentication process for each network connection including those network connections that must be reestablished due to connectivity issues.

### BRIEF SUMMARY

A method, apparatus and computer program product are provided in accordance with an example embodiment in order to facilitate the efficient establishment of a network connection that supports a stream having a plurality of stream features. As such, the method, apparatus and computer program product of an example embodiment may permit a network connection, such as XMPP connection, to be established with reduced latency while requiring the consumption of fewer processing resources, thereby benefitting both the client device and the server, as well as reducing overall network traffic. The savings provided in terms of latency and processing resources by the method, apparatus and computer program product of an example embodiment of the present invention may be particularly apparent in instances in which a network connection must be repeatedly reestablished, such as due to connectivity issues, as the savings will be experienced with each network connection.

In an example embodiment, a method is provided that includes providing for communication with a network entity in order to establish a network connection that supports a stream with the network entity. The stream is associated with a plurality of stream features. The method of this example embodiment also includes identifying one or more stream features from among the plurality of stream features based upon a feature negotiation conducted in conjunction with a prior network connection. The method of this example embodiment also includes causing the network entity to be informed of the one or more stream features and causing the stream to be utilized with the one or more stream features. In this regard, the method of an example embodiment may cause the network entity to be informed of the one or more stream features by causing a feature negotiation to be conducted with the network entity with respect to the one or more features without engaging in a feature negotiation with respect to other ones of the plurality of stream features, thereby improving the efficiency of the network connection establishment.

The identification of the one or more stream features may include, in an example embodiment, identifying the one or more stream features that were selected following a feature negotiation conducted in conjunction with the prior network connection. Additionally or alternatively, the identification of the one or more stream features may, in an example embodiment, include identifying the one or more stream features that are preferred. The method of an example embodiment may also include combining a plurality of features into a composite feature and causing a feature negotiation to be conducted with the network entity regarding the composite feature.

In another example embodiment, a computer program product may be provided that includes at least one non-transitory computer-readable storage medium having computer-executable program code portions stored therein with the computer-executable program code portions including program code portions configured, upon execution, to cause any of the foregoing methods to be performed.

In a further embodiment, an apparatus is provided that includes at least one processor and at least one memory including computer program code with the at least one memory and computer program code configured to, with the processor, cause the apparatus to at least provide for communication with the network entity in order to establish a network connection that supports a stream with the network entity. The stream is associated with a plurality of stream features. The at least one memory and the computer program code may also be configured to, with the processor, cause the apparatus of an example embodiment to identify one or more stream features from among the plurality of stream features based upon a feature negotiation conducted in conjunction with the prior network connection. The at least one memory and computer program code may also be configured to, with the processor, cause the apparatus of an example embodiment to cause a network entity to be informed of the one more stream features and to cause the stream to be utilized with the one or more stream features. In regards to causing the network entity to be informed of the one or more stream features, the at least one memory and computer program code may be configured to, with the processor, cause the apparatus of an example embodiment to cause the feature negotiation to be conducted with the network entity with respect to the one or more features without engaging in a feature negotiation with respect to other ones of the plurality of stream features.

The at least one memory and the computer program code may be configured to, with the processor, cause the apparatus of an example embodiment to identify the one or more stream features by identifying the one or more stream features that were seleced following the feature negotiation conducted in conjunction with the prior network connection. Additionally or alternatively, the at least one memory and computer program code may be configured to, with the processor, cause the apparatus to identify the one or more stream features by identifying the one or more stream features that are preferred. The at least one memory and computer program code may be further configured to, with the processor, cause the apparatus of an example embodiment to combine a plurality of features into a composite feature and to cause a feature negotiation to be conducted with the network entity regarding the composite feature.

In yet another example embodiment, an apparatus is provided that includes means for providing for communication with a network entity in order to establish a network connection that supports a stream with a network entity. The stream is associated with a plurality of stream features. The apparatus of this example embodiment may also include means for identifying one or more stream features from among the plurality of stream features based upon a feature negotiation conducted in conjunction with a prior network connection. The apparatus of this example embodiment may also include means for causing the network entity to be informed of the one or more stream features and means for causing the stream to be utilized with the one or more stream features. In this regard, the means for causing the network entity to be informed of the one or more stream features may include means for causing a feature negotiation to be conducted with the network entity with respect to the one or more features without engaging in a feature negotiation with respect to other ones of the plurality of stream features, thereby improving the efficiency of the network connection establishment.

The means for identifying the one or more stream features may include, in an example embodiment, means for identifying the one or more stream features that were selected following a feature negotiation conducted in conjunction with the prior network connection. Additionally or alternatively, the means for identifying the one or more stream features may, in an example embodiment, include means for identifying the one or more stream features that are preferred. The apparatus of an example embodiment may also include means for combining a plurality of features into a composite feature and means for causing a feature negotiation to be conducted with the network entity regarding the composite feature.

In an example embodiment, a method is provided that includes providing for communication with a client device in order to establish a network connection that supports a stream with the client device. The stream is associated with a plurality of stream features. The method of this example embodiment may also include receiving an identification of one or more stream features from among the plurality of stream features from the client device based upon a feature negotiation conducted in conjunction with a prior network connection. In this regard, the method may receive the identification of the one or more stream features without making a feature announcement in conjunction with the network connection. The method of this example embodiment may also include causing the stream to be utilized with the one or more stream features.

In an example embodiment, the one or more stream features were selected following the feature negotiation conducted in conjunction with the prior network connection. In another example embodiment, the one or more stream features are preferred by the client. The method of an example embodiment may also include causing a feature negotiation to be conducted with the client device regarding a composite feature into which a plurality of features have been combined.

In another example embodiment, a computer program product may be provided that includes at least one non-transitory computer-readable storage medium having computer-executable program code portions stored therein with the computer-executable program code portions including program code portions configured, upon execution, to cause any of the foregoing methods to be performed.

In a further example embodiment, an apparatus is provided that includes at least one processor and at least one memory including computer program code with the at least one memory and the computer program code configured to, with the processor, cause the apparatus to provide for communication with the client device in order to establish a network connection that supports a stream with the client device. A stream is associated with a plurality of stream features. The at least one memory and the computer program code may also be configured to, with the processor, cause the apparatus of this example embodiment to receive an identification of one or more stream features from among the plurality of stream features from the client device based upon a feature negotiation conducted in conjunction with a prior network connection. For example, the one or more stream features may have been selected following the feature negotiation conducted in conjunction with the prior network connection. Or, the one or more stream features that may have been selected may be preferred by the client. In this regard, the at least one memory and the computer program code may be configured to, with the processor, cause the apparatus to receive the identification of the one or more stream features without making a feature announcement in conjunction with the network connection. The at least one memory and the computer program product code may also be configured to, with the processor, cause the apparatus of this example embodiment to cause a stream to be utilized with the one or more stream features. The at least one memory and the computer program code may also be configured to, with the processor, cause the apparatus of an example embodiment to cause a feature negotiation to be conducted with the client device regarding a composite feature into which a plurality of features have been combined.

In yet another example embodiment, an apparatus is provided that includes means for providing for communication with the client device in order to establish a network connection that supports a stream with the client device. The stream is associated with a plurality of stream features. The apparatus of this example embodiment may also include means for receiving an identification of one or more stream features from among the plurality of stream features from the client device based upon a feature negotiation conducted in conjunction with a prior network connection. In this regard, the apparatus may receive the identification of the one or more stream features without making a feature announcement in conjunction with the network connection. The apparatus of this example embodiment may also include means for causing the stream to be utilized with the one or more stream features.

The one or more stream features may have been selected following the feature negotiation conducted in conjunction with the prior network connection. In another example embodiment, the one or more stream features are preferred by the client. The apparatus of an example embodiment may also include means for causing a feature negotiation to be conducted with the client device regarding a composite feature into which a plurality of features have been combined.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a signaling diagram associated with the establishment of XMPP connection and authentication;

FIG. 2 is a block diagram of a system including a client device, a client router and a server that may be specifically configured in order to support establishment of a network connection in accordance with an example embodiment of the present invention;

FIG. 3 is a block diagram of an apparatus that may be embodied by the client, client router, server or other network entity and that may be specifically configured in accordance with an example embodiment of the present invention;

FIG. 4 is a flow chart illustrating operations performed, such as by the apparatus of FIG. 3 as embodied by or otherwise associated with the client device, in accordance with an example embodiment of the present invention; and

FIG. 5 is a flow chart illustrating the operations performed, such as by the apparatus of FIG. 3 as embodied by a client router, a server or other network entity, in accordance with an example embodiment of the present invention.

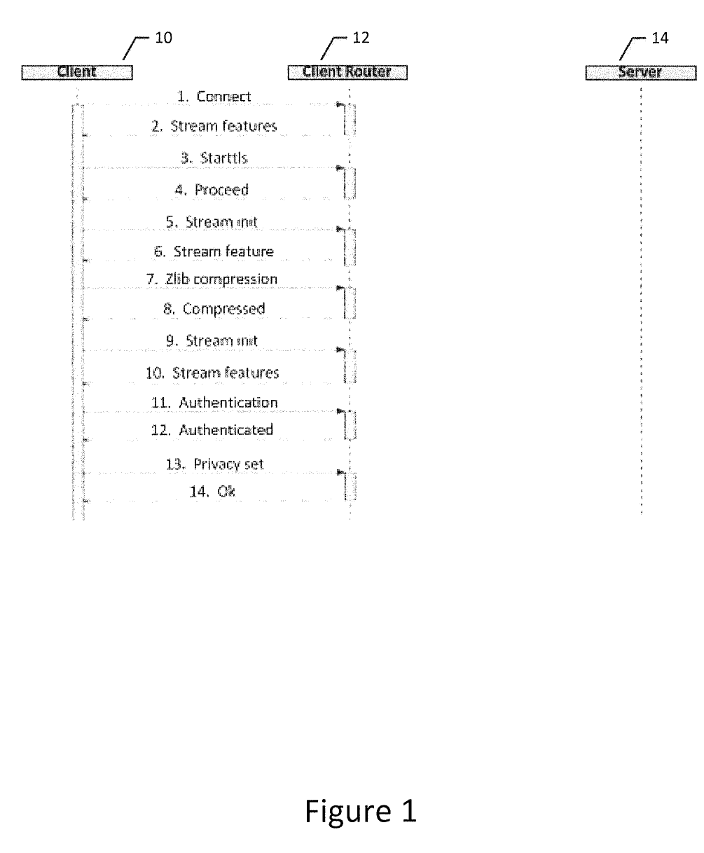

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

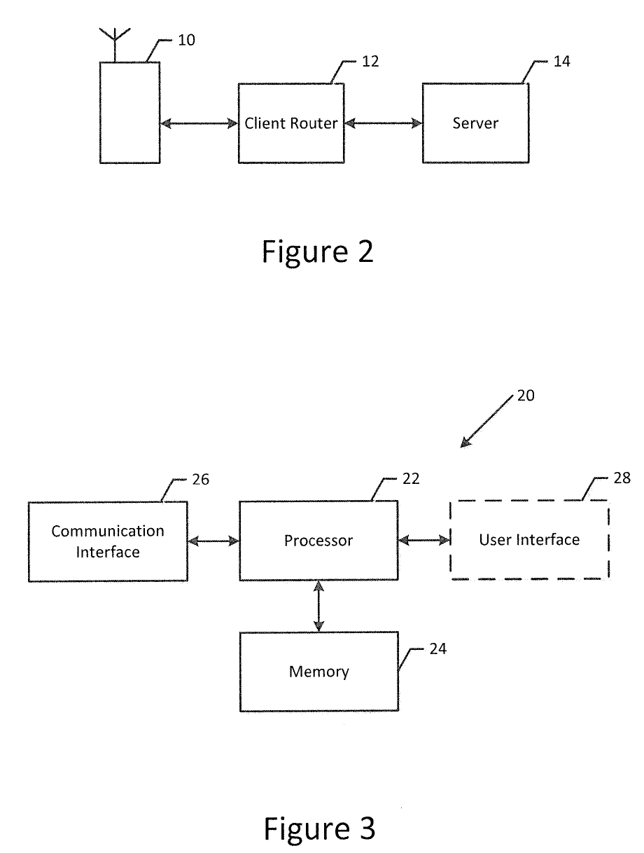

A method, apparatus and computer program product are provided in accordance with an example embodiment in order to establish a network connection, such as an XMPP connection, that supports a stream having a plurality of stream features in an efficient manner. By establishing the network connection, a client device 10 and a network entity, such as a client router 12, a server 14 or the like, may support various services and/or functions, such as the provision of internet service to the client device. A network connection may be established between a client device and one or more network entities in various manners. For example, a network connection may be established between a client device and a server via an intermediary client router as shown in FIG. 2. In this example, the client device, the client router and the server may communicate in accordance with an air interface standard of an applicable cellular system, and/or any number of different wireline or wireless networking techniques, comprising but not limited to Wi-Fi, Near Field Communications (NFC), BlueTooth, wireless local access network (WLAN) techniques such as Institute of Electrical and Electronics Engineers (IEEE) 802.11, 802.16, Worldwide Interoperability for Microwave Access (WiMAX) or other proximity-based communications protocols.

More particularly, the client device 10, the client router 12, the server 14 or other network entities may be configured to communicate via various wireless networks including those that operate in accordance with a first generation (1G) protocols, second generation (2G) protocols, 2.5G protocols, third-generation (3G) communication protocols, fourth-generation (4G) communication protocols, Internet Protocol Multimedia Subsystem (IMS) communication protocols (for example, session initiation protocol (SIP)), and/or the like. For example, the client device, the client router, the server or other network entities may be configured to communicate in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the client device, the client router, the server or other network entities may be configured to communicate in accordance with 2.5G wireless communication protocols General Packet Radio Service (GPRS), Enhanced Data GSM Environment (EDGE), and/or the like. Further, for example, the client device, the client router, the server or other network entities may be configured to communicate in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The client device, the client router, the server or other network entities may be configured to communicate in accordance with 3.9G wireless communication protocols such as Long Term Evolution LTE) or Evolved Universal Terrestrial Radio Access Network (E-UTRAN) and/or the like. Additionally, for example, the client device, the client router, the server or other network entities may be configured to communicate in accordance with fourth-generation (4G) wireless communication protocols and/or the like as well as similar wireless communication protocols that may be developed in the future.

The client device 10 may be embodied in various manners. For example, the client device may be embodied as a mobile terminal, such as a personal digital assistant (PDA), mobile telephone, smartphone, companion device, for example, a smart watch, pager, mobile television, gaming device, laptop computer, camera, tablet computer, touch surface, video recorder, audio/video player, radio, electronic book, positioning device (for example, global positioning system (GPS) device), or any combination of the aforementioned, and other types of voice and text communications systems. Alternatively, the client device may include a fixed computing device, such as personal computer, a desktop computer, a computer workstation or the like.

The network entity, such as the client router 12 (a backend service component that provides service to different clients), the server 14 or the like, may also be embodied in various manners. For example, the network entity may be embodied by a computing device, such as a personal computer, a computer workstation, a server computer, a router computer or the like.

Regardless of the manner in which the client device 10 and the network entity, such as the client router 12, the server 14 or the like, are embodied, the client device and/or the network entity may include or otherwise be associated with a respective apparatus 20 as shown in FIG. 3. In this regard, the apparatus may include may include or otherwise be in communication with a processor 22, a memory device 24, a communication interface 26 and optionally a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by the client device 10 and/or the network entity, such as the client router 12, the server 14 or the like. However, in some embodiments, the apparatus may be embodied as a chip or chip set. In other words, the apparatus may comprise one or more physical packages (for example, chips) including materials, components and/or wires on a structural assembly (for example, a circuit board). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the client device 10 and/or a network entity) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of the illustrated embodiment also includes a communication interface 26 that may be any means such as a device or circuitry embodied in either hardware or a combination of hardware and software that is configured to receive and/or transmit data from/to a communications device in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware and/or software for supporting communication via cable, digital subscriber line (DSL), universal serial bus (USB) or other mechanisms.

The apparatus 20 may also optionally include a user interface 28, such as in instances in which the apparatus is embodied by or otherwise associated with the client device 10. The user interface, such as a display, may be in communication with the processor 22 to provide output to the user and, in some embodiments, to receive an indication of a user input. In some embodiments, the user interface may also include a keyboard, a mouse, a joystick, touch areas, soft keys, one or more microphones, a plurality of speakers, or other input/output mechanisms. In an example embodiment, the processor may comprise user interface circuitry configured to control at least some functions of one or more user interface elements such as a display and, in some embodiments, a plurality of speakers, a ringer, one or more microphones and/or the like.

The processor and/or user interface circuitry comprising the processor may be configured to control one or more functions of one or more user interface elements through computer program instructions (for example, software and/or firmware) stored on a memory accessible to the processor (for example, memory device 24, and/or the like).

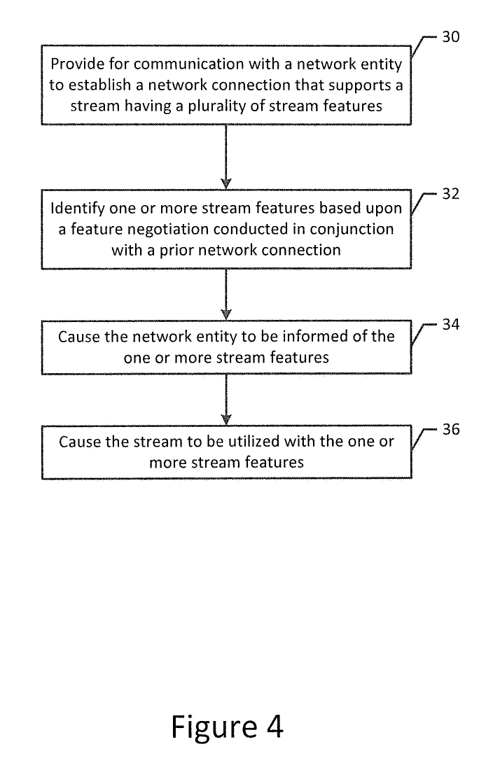

Referring now to FIG. 4, the operations performed from the perspective of the client device 10 in order to establish a network connection in accordance with an example embodiment of the present invention are illustrated. In this regard, as shown in block 30 of FIG. 4, the apparatus 20 embodied by or otherwise associated with the client device may include means, such as the processor 22, the communication interface 26 or the like, for providing for communication with a network entity, such as a client router 12, a server 14 or the like, in order to establish a network connection that supports a stream with the network entity. While various types of network connections may be established, one example of a network connection is an XMPP connection that supports an XML stream. The stream is associated with a plurality of stream features. Examples of stream features include the amp feature represented by the XML element<amp xmlns=‘http://jabbere.org/features/amp’>to provide support for advanced message processing, the compress feature represented by the XML element<compression xmlns=‘http://jabber.org/features/compress’>to provide support for stream compression, the iq-auth feature represented by the XML element<auth xmlns=‘http://jabber.org/features/iq-auth’>to provide support for non-SASL authentication, the iq-register feature represented by the XML element<register xmlns=‘http://jabber.org/features/iq-register’>to provide support for in-band registration, the bind feature represented by the XML element<bind xmlns=‘urn:ietf:params:xml:ns:xmpp-bind’>to provide support for resource binding, the mechanisms feature represented by the XML element<mechanisms xmlns=‘urn:ietf:params:xml:ns:xmpp-sasl’>to provide support for simple authentication and security layer (SASL), the session element represented by the XML element <session xmlns=‘urn:ietf:params:xml:ns:xmpp-session’>to provide support for IM session establishment, the starttls element represented by the XML element<starttls xmlns=‘urn:ietf:params:xml:ns:xmpp-tls’>to provide support for transport layer security (TLS), the bidi feature represented by the XML element<bidi xmlns=‘urn:xmpp:bidi’>to provide support for bidirectional server-to-server connections, the server dialback feature represented by the XML element<dialback xmlns=‘urn:xmpp:features:dialback’>to provide support for server dialback with dialback errors, the sm feature represented by the XML element<sm xmlns=‘urn:xmpp:sm:3’>to provide support for stream management. For at least some of the features, different options may exist. With respect to the compression feature, for example, different compression techniques, such as zlib or Lempel-Ziv-Welch (lzw) may be selected.

As shown in block 32 of FIG. 4, the apparatus 20 embodied by or otherwise associated with the client device 10 may also include means, such as the processor 22, the memory 24 or the like, for identifying one or more stream features from among the plurality of stream features associated with the streams supported by the network connection. The one or more stream features that are identified are based upon a feature negotiation conducted in conjunction with a prior network connection, such as a prior network connection between the client device and the same network entity, such as the same server 14, with which the network connection is currently sought to be established.

The apparatus 20, such as the processor 22, the memory 24 or the like, may be configured to identify the one or more stream features based upon a feature negotiation conducted in conjunction with the prior network connection in various manners. For example, the apparatus, such as the processor, the memory or the like, may have stored a list of the stream features that were selected following the feature negotiation conducted in conjunction with the prior network connection. Thus, the feature negotiation that was conducted in conjunction with the prior network connection need not be repeated, but the network connection may, instead, be established employing the same stream features that were previously selected in conjunction with the prior network connection. Additionally or alternatively, the apparatus, such as the processor, the memory or the like, may be configured to identify the one or more stream features by identifying one or more stream features that are preferred by the client device. In this regard, the apparatus, such as the processor, the memory or the like, may store a list of one or more stream features that are preferred and these preferred stream features may subsequently be identified and utilized in conjunction with the establishment of a subsequent network connection in order to improve the efficiency with which the network connection is established. The stream features that are identified as being preferred may be all or some of the same stream features but were selected following the feature negotiation conducted in conjunction with the prior network connection, or may be a different set of stream features that the client device, such as the user of the client device, has determined are preferred.

As shown in block 34 of FIG. 4, the apparatus 20 embodied by or otherwise associated with the client device 10 may also include means, such as the processor 22, the communication interface 26 or the like, for causing the network entity to be informed of the one or more stream features that have been identified, such as by causing a message to be sent to the network entity, such as a client router 12 and/or the server 14, identifying the one or more stream features. In this regard, the apparatus, such as the processor, the communication interface or the like, may cause the network entity to be informed of the one or more stream features such that a feature negotiation is caused to be conducted with the network entity with respect to the one or more stream features that are identified, without engaging in a feature negotiation with respect to other ones of the plurality of stream features. For example, the network entity need not advertise the availability of the other stream features and the client device need not decline the other stream features since the particular stream features that are desired by the client device for the network connection have already been identified, thereby reducing the signaling that is required and the processing that would otherwise be necessitated.

By way of an example, a stream supported by a network connection may have stream features A, B, C, D, E and F and the client device 10, based upon the feature negotiation conducted in conjunction with the prior network connection, may have already identified stream features A, C and F as the only stream features that are desired for the network connection. In this example, the network entity may be informed by the client device that the network connection should include stream features A, C and F. As such, the client device and the network entity need not engage in any feature negotiation with respect to the other stream features, that is, stream features B, D and E.

As shown in block 36 of FIG. 4, the apparatus 20 may also include means, such as the processor 22, the communication interface 26 or the like, for causing the stream to thereafter be utilized with the one or more stream features in conjunction with the network connection that is established with the network entity. By having caused the network connection to be established based upon stream features that are identified from a feature negotiation conducted in conjunction with a prior network connection, however, the current network connection may be established in a more efficient manner with less signaling, the consumption of fewer processing resources and reduced latency. A more efficient establishment of a network connection in accordance with an example embodiment of the present invention may be even more advantageous in an instance in which the network connection must be repeatedly reestablished, such as in instances in which there are connectivity issues.

In an example embodiment, the apparatus 20 embodied by or otherwise associated with the client device 10 may include means, such as the processor 22, the communication interface 26 or the like, for combining a plurality of stream features into a composite feature and for causing a feature negotiation to be conducted with a network entity regarding the composite feature. As such, a single feature negotiation may be conducted to establish the plurality of stream features that are included within the composite feature, thereby further increasing the efficiency with which a network connection may be established.

Although the client device 10 and the network entity, such as the client router 12, the server 14 or the like, may be configured to exchange a variety of different types of messages in order to establish a network connection in accordance with an example embodiment, one example of the messages exchanged between the client device and the client router in order to provide for an XMPP connection and authentication is set forth below:

1. Xml to clirent router
<?xml version=’1.0’?><stream:stream to=’ovi.com’ xmlns=’jabber:client’
xmlns:stream=’http://etherx.jabber.org/streams’ xml:lang=’en’ version=’1.0’>
2. Xml to client
<stream:stream xmlns=’jabber:client’ xmlns:stream=’http://etherx.jabber.org/streams’
id=’2428957356’ from=’ovi.com’ version=’1.0’ xml:lang=’en’/>
3. Xml to client
<stream:features><starttls xmlns=”urn:ietf:params:xml:ns:xmpp-tls”></starttls><starttls_zlib
xmlns=”nokia:xmpp-tls-zlib”/><starttlsx xmlns=”nokia:xmpp-tlsp”/><compression
xmlns=”http://jabber.org/features/compress”><method>zlib</method></compression><compressx
xmlns=”nokia:xmpp-zlib”><method>zlib</method></><compress><bind xmlns=”nokia:xmpp-
bind”/><mechanisms xmlns=”urn:ietf:params:xml:ns:xmpp-sasl”><mechanism>X-NOKIA-
TOKEN1</mechanism><mechanism>PLAIN</mechanism><mechanism>X-NOKIA-
TOKEN</mechanism><mechanism>DIGEST-MD5</mechanism></mechanism><mechanisms
xmlns=”nokia:xmpp-sasl”><mechanism>X-NOKIA-
TOKEN1</mechanism><mechanism>PLAIN</mechanism><mechanism>X-NOKIA-
TOKEN</mechanism><mechanism>DIGEST-
MD5</mechanism></mechanisms></stream:features>
4. Xml to client router
<starttls_zlib xmlns=’nokia:xmpp-tls-zlib’/>
5. Xml to client
<proceed xmlns=’nokia:xmpp-tls-zlib’/>
6. Xml to client router
<auth xmlns=’nokia:xmpp-sasl’ mechanism=’DIGEST-MD5’/>
7. Xml to client
<challenge xmlns=’nokia:xmpp-sasl’>Challenge </challenge>
8. Xml to client router
<response xmlns=’nokia:xmpp-sasl’>Challenge_response</response>
9. Xml to cient
<success xmlns:nx=’http://nokia.com/protocol/xmpp’ xmlns=’nokia:xmpp-sasl’/>
10. Xml to client router
<iq id=’46dae74220bad7b4659eff6e30a0008c’ type=’set’
from=’w5uf97d28zycjj4wmz9a231za96jcjz@ovi.com’ xmlns=’jabber:client’><bind
xmlns=’nokia:xmpp-bind’><resource>123456789</resource></bind></iq>
11. Xml to client
<iq id=’46dae74220bad7b4659eff6e30a0008c’ type=’result’><bind xmlns=’nokia:xmpp-
bind’><jid>w5uf97d28zycjj4wmz9a231za96jcjz@ovi.com/123456789</jid></bind></iq>

As shown in the example above, a network connection may be established without re-initiation of an XML stream. In addition, the Starttls_zlib→tls negotiation in which the server 14 sends the STARTTLS extension to the client device 10 along with authentication mechanisms and any other stream features and the zlib compression may be combined, such as into a composite feature, as shown in Message 3, thereby combining the stream features relating to transport layer security (TLS) and the zlib compression algorithm. Further, the MD5 authentication does not send the last response authentication (rspauth), the bind includes the session (requested by the client device and created by the server), there is no initial presence and no privacy list.

Another example of the messages exchanged in accordance with an example embodiment of the present invention in order to establish a network connection between devices that utilize an embedded Series 40 (S40) platform is set forth below:

1. Xml to client router
<?xml version=’1.0’?><stream:stream to=’ovi.com’ xmlns=’jabber:client’
xmlns:stream=’http://etherx.jabber.org/streams’ xml:lang=‘en’ version=‘1.0’>
2. Xml to client
<stream:stream xmlns=‘jabber:client’ xmlns:stream=‘http://etherx.jabber.org/streams’
id=‘2428957356’ from=‘ovi.com’ version=‘1.0’ xml:lang=‘en’/>
3. Xml to client
<stream:features><compression
xmlns=“http://jabber.org/features/compress”><method>zlib</method></compression><compressx
xmlns=“nokia:xmpp-zlib”><method>zlib</method></compressx><mechanisms
xmlns=“urn:ietf:params:xml:ns:xmpp-sasl”><mechanism>X-NOKIA-
TOKEN1</mechanism><mechanism>PLAIN</mechanism><mechanism>X-NOKIA-
TOKEN</mechanism><mechanism>DIGEST-MD5</mechanism></mechanisms><mechanisms
xmlns=“nokia:xmpp-sasl”><mechanism>X-NOKIA-
TOKEN1</mechanism><mechanism>PLAIN</mechanism><mechanism>X-NOKIA-
TOKEN</mechanism><mechanism>DIGEST-MD5</mechanism></mechanisms><bind
xmlns=“nokia:xmpp-bind”/></stream:features>
4. Xml to clirent router
<compressx xmlns=‘nokia:xmpp-zlib’><method>zlib</method></compressx>
5. Xml to client
<compressed xmlns=‘nokia:xmpp-zlib’/>
6. Xml to clirent router
<auth xmlns=‘nokia:xmpp-sasl’ mechanism=‘DIGEST-MD5’/>
7. Xml to client
<challenge xmlns=‘nokia:xmpp-sasl’> Challenge</challenge>
8. Xml to clirent router
<response xmlns=‘nokia:xmpp-sasl’> Challenge response/response>
9. Xml to client
<success xmlns:nx=‘http://nokia.com/protocol/xmpp’ xmlns=‘ nokia:xmpp-sasl’/>
10. Xml to clirent router
<iq id=‘46dae74220bad7b4659eff6e30a0008c’ type=‘set’
from=‘w5uf97d28zycjj4wmz9a231za96jcjz@ovi.com’ xmlns=‘jabber:client’><bind
xmlns=‘nokia:xmpp-bind’><resource>123456789</resource></bind></iq>
11. Xml to client
<iq id=‘46dae74220bad7b4659eff6e30a0008c’ type=‘result’><bind xmlns=‘nokia:xmpp-
bind’><jid>w5uf97d28zycjj4wmz9a231za96jcjz@ovi.com/ 123456789</jid></bind></iq>

In the same manner as the prior example, this message sequence does not re-initialize the XML stream, the MD5 authentication does not send the last rspauth, the bind includes the session, there is no initial presence and no privacy list. However, in contrast to the prior message sequence, the zlib compression is provided without a new feature list and with no stream re-initialization.

In an example embodiment, the client device 10 may store the preferred or the previously selected stream features and may provide the list of preferred stream features to the network entity during the initial stream establishment. In response to a message from the network entity, such as a server 14, to proceed with the list of preferred stream features, the client device may, in one example, implement the stream features. For example, the preferred stream features may include an upgraded connection to TLS and the use of zlib compression such that the client device may begin upgrading the connection to TLS and initiate the zlib compression in response to the message to proceed with the preferred stream features. In another embodiment, a preferred stream feature may include zlib compression, but not an upgraded connection to TLS, such that the client only initiates the zlib compression in response to the message to proceed with the preferred stream features. Alternatively, the server may store the preferred or previously selected stream features and may provide the list of preferred stream features to the client device during the initial stream establishment.

In order to further increase the efficiency of the establishment of the network connection, an apparatus 20, such as the processor 22, the communication interface 26 or the like, embodied by or otherwise associated by the client device 10 may be configured to send a resource during the authentication process in order to bind the client device without undergoing a separate binding process following the authentication of the client device. In this example embodiment, in response to providing the resource during the authentication process, the network entity may provide and the client device may receive the full Jabber Identifier (JID) in the authentication response so as to facilitate binding of the client device in an efficient manner. However, in an instance in which the network device does not respond with the full JID in the authentication response, the client device may proceed with a conventional binding process following the authentication process. By way of example, the messages exchanged by a client device and a network entity, such as a client router 12, in accordance with an example embodiment in which the preferred stream features are included in the initial connection stanza and the bind is included in the authentication process may be as follows:

1. Xml to client router
<?xml version=‘1.0’ ?><stream:stream to=‘ovi.com’ xmlns=‘jabber:client’
xmlns:stream=‘http://etherx.jabber.org/streams’ version=‘1.0’ xmlns:features=‘nokia:xmpp-tls-zlib’>
2. Xml to client
<stream:features><bind xmlns=“nokia:xmpp-bind”/><mechanisms xmlns=“nokia:xmpp-
sasl”><mechanism>X-NOKIA-
TOKEN1</mechanism><mechanism>PLAIN</mechanism><mechanism>X-NOKIA-
TOKEN</mechanism><mechanism>DIGEST-MD5</mechanism></mechanisms><proceed
xmlns=‘nokia:xmpp-zlib’></stream:features>
w5uf97d28zycjj4wmz9a231za96jcjz@ovi.com/123456789</jid></success>
3. Xml to client router
<auth xmlns=‘nokia:xmpp-sasl’ mechanism=‘DIGEST-MD5’ resource=‘123456789’/>
4. Xml to client
<challenge xmlns=‘nokia:xmpp-sasl’>Challenge</challenge>
5. Xml to client router
<response xmlns=‘nokia:xmpp-sasl’>Challenge response</response>
6. Xml to client
<success xmlns:nx=‘http://nokia.com/protocol/xmpp’ xmlns=‘ nokia:xmpp-sasl’><id>
W5uf97d28zycjj4wmz9a231za96jcjz@ovi.com/123456789</jid></success>

In the foregoing example, the list of preferred stream features, namely TLS and zlib, are included in the initial connection stanza, for example, xmlns:features=‘nokia:xmpp-tls-zlib’. The network entity, such as the server 14, responds with only the preferred stream features without any feature negotiation regarding other stream features. In this regard, the instructions to proceed with the preferred stream features is included in stream:features and the bind is included in the authentication message. Another example of the messages exchanged between a client device 10 and a network entity, such as a client router 12, that utilize an S40 platform that provides the preferred stream features in the initial connection stanza and the bind in the authentication message may be as follows:

1. Xml to client router
<?xml version=‘1.0’ ?><stream:stream to=‘ovi.com’ xmlns=‘jabber:client’
xmlns:stream=‘http://etherx.jabber.org/streams’ version=‘1.0‘ xmlns:features=‘nokia:xmpp-zlib’>
2. Xml to client
<stream:features><bind xmlns=“nokia:xmpp-bind”/><mechanisms xmlns=“nokia:xmpp-
sasl”><mechanism>X-NOKIA-
TOKEN1</mechanism><mechanism>PLAIN</mechanism><mechanism>X-NOKIA-
TOKEN</mechanism><mechanism>DIGEST-MD5</mechanism></mechanisms><compressed
xmlns=‘nokia:xmpp-zlib’/></stream:features>
3. Xml to client router
<auth xmlns=‘nokia:xmpp-sasl’ mechanism=‘DIGEST-MD5’ resource=‘123456789’>
4. Xml to client
<challenge xmlns=‘nokia:xmpp-sasl’>Challenge</challenge>
5. Xml to client router
<response xmlns=‘nokia:xmpp-sasl’> Challenge response</response>
6. Xml to client
<success xmlns:nx=‘http://nokia.com/protocol/xmpp’ xmlns=‘ nokia:xmpp-sasl’><jid>
w5uf97d28zycjj4wmz9a231za96jcjz@ovi.com/123456789</jid></success>

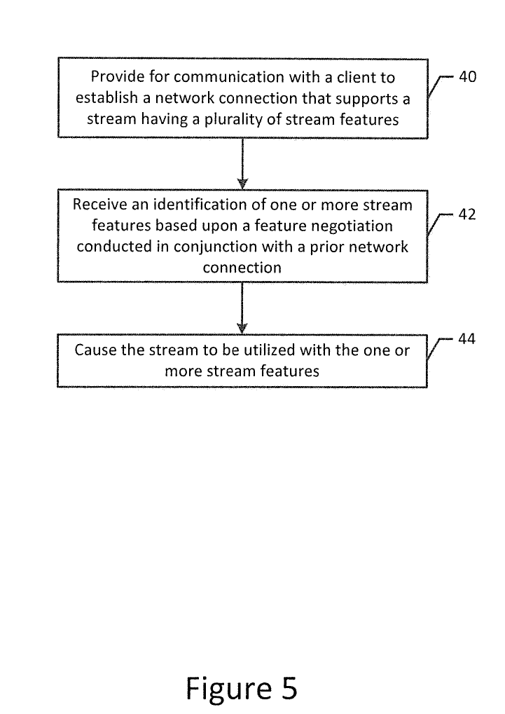

Referring now to FIG. 5, the operations performed by an apparatus 20 embodied by or otherwise associated with a network entity, such as a client router 12, a server 14 or the like, in order to establish a network connection in an efficient manner are described below. In this regard, as shown in block 40 of FIG. 5, the apparatus embodied by or otherwise associated with the network entity may include means, such as the processor 22, the communication interface 26 or the like, for providing for communication with a client device 10 in order to establish a network connection that supports a stream with the client device. In this regard, the stream is associated with a plurality of stream features.

As shown in block 42, the apparatus 20 embodied by or otherwise associated with a network entity may also include means, such as the processor 22, the communication interface 26 or the like, for receiving an identification of one or more stream features based upon a feature negotiation conducted in conjunction with a prior network connection. For example, the network entity may receive a list of stream features from a client device 10 that were selected by the client device following the feature negotiation conducted in conjunction with a prior network connection. Additionally or alternatively, the network entity may receive a list of stream features that are preferred by the client device, which may be the same or different than the stream features that were selected following the feature negotiation conducted in conjunction with a prior network connection. In yet another embodiment in which the network entity, such as the server 14, has stored the preferred or previously selected stream features, the network entity may provide the list of preferred stream features to the client device during the initial stream establishment such that the identification of the one or more features that is received from the client device may be in the form of a confirmation from the client device of one or all of the preferred stream features provided by the network entity.

As shown in block 44 of FIG. 5, the apparatus 20 embodied by or otherwise associated with a network entity may also include means, such as the processor 22, the communication interface 26 or the like, for causing the stream to be utilized with the one or more stream features during the network connection established with the client device 10. In this regard, the identification to one or more stream features may be received without making a feature announcement in conjunction with the network connection and without engaging in a feature negotiation with respect to any stream features that are not identified by the client device to be of interest. As such, the network entity may be configured so as to more efficiently establish a network connection with the client device in order to further increase the efficiency with which the network connection may be established.

In an example embodiment, the apparatus 20 embodied by or otherwise associated with the network entity may include means, such as the processor 22, the communication interface 26 or the like, for causing a feature negotiation to be conducted with the client device regarding a composite feature into which a plurality of features have been combined. As such, a single feature negotiation may be conducted to establish the plurality of features that are included within the composite feature, thereby further increasing the efficiency with which a network connection may be established.

As described above, FIGS. 4 and 5 illustrate flowcharts of an apparatus 20, method and computer program product according to example embodiments of the invention from the perspective of a client device 10 in regards to FIG. 4 and from the perspective of a client router 12, a server 14 or other network entity in regards to FIG. 5. It will be understood that each block of the flowcharts, and combinations of blocks in the flowcharts, may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 24 of an apparatus employing an embodiment of the present invention and executed by a processor 22 of the apparatus. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-32. (canceled)

33. A method comprising:
providing for communication with a network entity in order to establish a network connection that supports a stream with the network entity, wherein the stream is associated with a plurality of stream features;
identifying one or more stream features from among the plurality of stream features based upon a feature negotiation conducted in conjunction with a prior network connection; and
causing the network entity to be informed of the one or more stream features;
causing the stream to be utilized with the one or more stream features.

34. A method according to claim 33 wherein identifying the one or more stream features comprises identifying the one or more stream features that were selected following the feature negotiation conducted in conjunction with the prior network connection.

35. A method according to claim 33 wherein identifying the one or more stream features comprises identifying the one or more stream features that are preferred.

36. A method according to claim 33 further comprising:
combining a plurality of features into a composite feature; and
causing a feature negotiation to be conducted with the network entity regarding the composite feature.

37. A method according to claim 33 wherein causing the network entity to be informed of the one or more stream features comprises causing a feature negotiation to be conducted with the network entity with respect to the one or more features without engaging in a feature negotiation with respect to other ones of the plurality of stream features.

38. An apparatus comprising at least one processor and at least one memory including computer program code, the at least one memory and the computer program code configured to, with the processor, cause the apparatus to at least:
provide for communication with a network entity in order to establish a network connection that supports a stream with the network entity, wherein the stream is associated with a plurality of stream features;
identify one or more stream features from among the plurality of stream features based upon a feature negotiation conducted in conjunction with a prior network connection;
cause the network entity to be informed of the one or more stream features; and
cause the stream to be utilized with the one or more stream features.

39. An apparatus according to claim 38 wherein the at least one memory and the computer program code are configured to, with the processor, cause the apparatus to identify the one or more stream features by identifying the one or more stream features that were selected following the feature negotiation conducted in conjunction with the prior network connection.

40. An apparatus according to claim 38 wherein the at least one memory and the computer program code are configured to, with the processor, cause the apparatus to identify the one or more stream features by identifying the one or more stream features that are preferred.

41. An apparatus according to claim 38 wherein the at least one memory and the computer program code are further configured to, with the processor, cause the apparatus to:
combine a plurality of features into a composite feature; and
cause a feature negotiation to be conducted with the network entity regarding the composite feature.

42. An apparatus according to claim 38 wherein the at least one memory and the computer program code are configured to, with the processor, cause the apparatus to cause the network entity to be informed of the one or more stream features by causing a feature negotiation to be conducted with the network entity with respect to the one or more features without engaging in a feature negotiation with respect to other ones of the plurality of stream features.

43. A method comprising:
providing for communication with a client device in order to establish a network connection that supports a stream with the client device, wherein the stream is associated with a plurality of stream features;
receiving an identification of one or more stream features from among the plurality of stream features from the client device based upon a feature negotiation conducted in conjunction with a prior network connection; and
causing the stream to be utilized with the one or more stream features.

44. A method according to claim 43 wherein the one or more stream features were selected following the feature negotiation conducted in conjunction with the prior network connection.

45. A method according to claim 43 wherein the one or more stream features are preferred by the client device.

46. A method according to claim 43 further comprising causing a feature negotiation to be conducted with the client device regarding a composite feature into which a plurality of features have been combined.

47. A method according to claim 43 wherein receiving the identification of one or more stream features comprises receiving the identification of the one or more stream features without making a feature announcement in conjunction with the network connection.

48. An apparatus comprising at least one processor and at least one memory including computer program code, the at least one memory and the computer program code configured to, with the processor, cause the apparatus to at least:
provide for communication with a client device in order to establish a network connection that supports a stream with the client device, wherein the stream is associated with a plurality of stream features;
receive an identification of one or more stream features from among the plurality of stream features from the client device based upon a feature negotiation conducted in conjunction with a prior network connection; and
cause the stream to be utilized with the one or more stream features.

49. An apparatus according to claim 48 wherein the one or more stream features were selected following the feature negotiation conducted in conjunction with the prior network connection.

50. An apparatus according to claim 48 wherein the one or more stream features are preferred by the client device.

51. An apparatus according to claim 48 wherein the at least one memory and the computer program code further configured to, with the processor, cause the apparatus to cause a feature negotiation to be conducted with the client device regarding a composite feature into which a plurality of features have been combined.

52. An apparatus according to claim 48 wherein the at least one memory and the computer program code are configured to, with the processor, cause the apparatus to receive the identification of one or more stream features by receiving the identification of the one or more stream features without making a feature announcement in conjunction with the network connection.
